(19) United States
(12) Patent Application Publication
(10) Pub. No.: US 2024/0204713 A1
(43) Pub. Date: Jun. 20, 2024

(54) PHOTOVOLTAIC ROOFING TILE BASE

(71) Applicant: Tesla, Inc., Austin, TX (US)

(72) Inventors: Tommy F. RODRIGUES, San Ramon, CA (US); Gregory PATNUDE, Oakland, CA (US)

(21) Appl. No.: 18/544,323

(22) Filed: Dec. 18, 2023

Related U.S. Application Data
(60) Provisional application No. 63/434,007, filed on Dec. 20, 2022.

(51) Int. Cl. H02S 20/25

(52) U.S. Cl. CPC H02S 20/25

(57) ABSTRACT

A configuration for a roofing tile base compatible with both photovoltaic (PV) and non-PV roofing tiles is described herein. The roofing tile base includes a first set of retaining features for being secured to a non-PV roofing tile and a second set of retaining features for being secured to a PV roofing tile. In particular, the roofing tile base includes a number of apertures sized to receive tile hooks positioned on a roof-facing surface of a PV roofing tile. Engagement by a respective hook of a portion of the roofing tile base defining the aperture helps to secure the PV roofing tile to the roofing tile base. The roofing tile base also includes retaining features on opposing lateral sides of the roofing tile base that are configured to lock into notches arranged on opposing sidewalls of a non-PV roofing tile.

### CROSS-REFERENCE TO RELATED APPLICATIONS

This application claims priority to U.S. Provisional Patent Application Ser. No. 63/434,007, entitled “PHOTOVOLTAIC ROOFING TILE BASE,” filed Dec. 20, 2022, the contents of which are hereby incorporated by reference in their entirety.

### BACKGROUND

### Field

This disclosure is generally related to photovoltaic (PV) roofing tiles. More specifically, this disclosure describes a universal roofing base configured to support either a PV roofing tile or a non-PV roofing tile.

### Related Art

In residential and commercial solar energy installations, a building's roof is typically installed with PV modules, also called PV or solar panels, that can include a two-dimensional array (e.g., 6×12) of solar cells. A PV roofing tile (or solar roofing tile) can be a particular type of PV module offering weather protection for the home and a pleasing aesthetic appearance, while also functioning as a PV module to convert solar energy to electricity. The PV roofing tile can be shaped like a conventional roofing tile and can include one or more solar cells encapsulated between a front cover and a back cover, but typically encloses fewer solar cells than a conventional solar panel.

The front and back covers can be fortified glass or other material that can protect the PV cells from the weather elements. Note that a typical roofing tile may have a dimension of 15 in×8 in=120 in²=774 cm², and a typical solar cell may have a dimension of 6 in×6 in=36 in²=232 cm². Generally, a PV roofing tile installation will include a mix of PV roofing tiles and non-PV roofing tiles since incorporating PV structures into every roofing tile would typically provide more energy than needed to power a typical residence. For this reason, roofing elements that can be used with both PV and non-PV roofing tile modules are desirable and could improve affordability of PV roofing configurations.

### SUMMARY

In some embodiments, a roofing tile base includes features allowing the roofing tile base to support both PV roofing tiles and non-PV roofing tiles.

In some embodiments, a roofing tile assembly is disclosed and includes the following: a photovoltaic (PV) roofing tile, comprising: an optically transparent front cover; a back cover; a plurality of solar cells disposed between the optically transparent front cover and the back cover; and a plurality of tile hooks coupled to the back cover; and a roofing tile base, comprising: a sun-facing surface in direct contact with the back cover and extending from a first lateral side of the roofing tile to a second lateral side of the roofing tile opposite the first lateral side; a plurality of vertical standoffs configured to establish a height of the sun-facing surface above a roofing substrate; and a plurality of apertures extending through the roofing tile base, wherein a first tile hook of the plurality of tile hooks extends through a first aperture of the plurality of apertures and engages a portion of the roofing tile base defining the first aperture.

In some embodiments, a roofing tile assembly is disclosed and includes the following: a non-photovoltaic (non-PV) roofing tile, comprising: a sheet metal substrate comprising: a flat central region, a first sidewall at a first end of the flat central region and defining a first notch; and a second sidewall at a second end, opposite the first end, of the flat central region and defining a second notch; and a roofing tile base, comprising: a sun-facing surface in direct contact with the flat central region and extending from the first sidewall to the second sidewall; a plurality of vertical standoffs configured to establish a height of the sun-facing surface above a roofing substrate; a first retaining feature on a first lateral side of the roofing tile base engaged within the first notch of the first sidewall; and a second retaining feature on a second lateral side of the roofing tile base engaged within the second notch of the second sidewall.

In some embodiments, a roof configuration is disclosed and includes the following: a first roofing tile assembly, comprising: a first roofing tile base; and a photovoltaic (PV) roofing tile disposed atop the first roofing tile base; and a second roofing tile assembly adjacent to the first roofing tile assembly, the second roofing tile assembly comprising: a second roofing tile base; and a non-photovoltaic (non-PV) roofing tile disposed atop the second roofing tile base, wherein the first roofing tile base is the same as the second roofing tile base.

A “solar cell strip,” “PV strip,” “smaller cell,” or “strip” is a portion or segment of a PV structure, such as a solar cell. A PV structure may be divided into a number of strips. A strip may have any shape and any size. The width and length of a strip may be the same or different from each other. Strips may be formed by further dividing a previously divided strip.

“Finger lines,” “finger electrodes,” and “fingers” refer to elongated, electrically conductive (e.g., metallic) electrodes of a PV structure for collecting carriers.

“Busbar,” “bus line,” or “bus electrode” refer to elongated, electrically conductive (e.g., metallic) electrodes of a PV structure for aggregating current collected by two or more finger lines. A busbar is usually wider than a finger line, and can be deposited or otherwise positioned anywhere on or within the PV structure. A single PV structure may have one or more busbars.

A “PV structure” can refer to a solar cell, a segment, or a solar cell strip. A PV structure is not limited to a device fabricated by a particular method. For example, a PV structure can be a crystalline silicon-based solar cell, a thin film solar cell (e.g., CdTe or CIGS thin film solar cell), an amorphous silicon-based solar cell, a polycrystalline silicon-based solar cell, or a strip thereof.

### BRIEF DESCRIPTION OF THE FIGURES

FIG. 1 shows an exemplary configuration of PV roofing tiles on a house.

FIG. 2 shows a perspective front view of an exemplary PV roofing tile, according to an embodiment.

FIG. 3A shows an exemplary configuration of a multi-tile module, according to one embodiment.

FIG. 3B shows a cross-section of an exemplary multi-tile module, according to one embodiment.

FIG. 4A illustrates a serial connection among three adjacent cascaded PV strips, according to one embodiment.

FIG. 4B illustrates a side view of the string of cascaded strips, according to one embodiment.

FIG. 4C illustrates an exemplary solar roofing tile, according to one embodiment.

FIG. 5A shows a top view of an exemplary multi-tile module, according to one embodiment.

FIG. 5B shows a top view of another exemplary solar roofing tile, according to one embodiment.

FIG. 6 shows a partial view of a roof having a number of solar roofing tiles and passive roofing tiles.

FIGS. 7A-7B show perspective views of respective sun-facing and roof facing surfaces of a roofing tile base.

FIG. 7C shows engagement of a lateral standoff of a first roofing tile base within an alignment notch of a second roofing tile base.

FIG. 7D shows a cross-sectional view of two roofing tile bases in accordance with section line A-A from FIG. 7C.

FIG. 7E shows a perspective view of corner portions of laterally adjacent roofing tile bases.

FIG. 7F shows a cross-sectional view of roofing tile bases with an integrated sidelap in accordance with section line B-B.

FIG. 8A shows a perspective view of a PV roofing tile.

FIG. 8B shows a perspective view of the PV roofing tile shown in FIG. 8A positioned atop a roofing tile base.

FIG. 8C shows PV roofing tile fully engaged with a roofing tile base.

FIG. 9A shows a non-PV roofing tile and how it is configured to slide on to roofing tile base.

FIG. 9B shows a non-PV roofing tile fully engaged with a roofing tile base.

FIGS. 10A-10E depict an exemplary process for installing roofing tiles on multiple roofing tile bases on a house.

FIGS. 11A-11F show how a height of various portions of a roofing tile base varies.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the disclosed system is not limited to the embodiments shown, but is to be accorded the widest scope consistent with the principles and features disclosed herein.

### Overview

Embodiments of the invention solve at least the technical problem of reducing the number of components needed to join PV and non-PV roofing tiles together. In particular, this disclosure describes a universal roofing tile base capable of coupling to both PV and non-PV roofing tiles. The roofing tile base includes multiple apertures that can be engaged by multiple hooks disposed on a roof-facing side of a PV roofing tile. The hooks engage an edge portion of a respective aperture to secure the PV roofing tile to the roofing tile base. The roofing tile base also includes retaining features to secure the roofing tile base to a roofing substrate.

In addition to describing a new PV roofing tile base, advancements are described with regards to formation of a robust and flexible non-PV roofing tile. In particular, the roofing tile can be formed from sheet metal and finished to have the appearance of a PV roofing tile. Formation of the roofing tile from a sheet metal material results in a non-PV roofing tile that can be efficiently cut to fit portions of a roof top that would not otherwise be able to accommodate a rectangular roofing tile. For example, a stock rectangular non-PV roofing tile can be cut to have almost any polygonal shape. A number of triangular tiles can be needed near various ridges and/or valleys of a particular roof top. A triangular or trapezoidal piece can be formed by applying one or two cuts to a non-PV roofing tile. The combination of multi-use feet and non-PV roofing tiles formed from metal can substantially reduce the variety of parts needed to perform a PV roof installation.

A “solar cell” or “cell” is a PV structure capable of converting light into electricity. A cell may have any size and any shape, and may be created from a variety of materials. For example, a solar cell may be a PV structure fabricated on a silicon wafer or one or more thin films on a substrate material (e.g., glass, plastic, or any other material capable of supporting the PV structure), or a combination thereof.

A “solar cell strip,” “PV strip,” “smaller cell,” or “strip” is a portion or segment of a PV structure, such as a solar cell. A PV structure may be divided into a number of strips. A strip may have any shape and any size. The width and length of a strip may be the same or different from each other. Strips may be formed by further dividing a previously divided strip.

“Finger lines,” “finger electrodes,” and “fingers” refer to elongated, electrically conductive (e.g., metallic) electrodes of a PV structure for collecting carriers.

“Busbar,” “bus line,” or “bus electrode” refer to elongated, electrically conductive (e.g., metallic) electrodes of a PV structure for aggregating current collected by two or more finger lines. A busbar is usually wider than a finger line, and can be deposited or otherwise positioned anywhere on or within the PV structure. A single PV structure may have one or more busbars.

A “PV structure” can refer to a solar cell, a segment, or a solar cell strip. A PV structure is not limited to a device fabricated by a particular method. For example, a PV structure can be a crystalline silicon-based solar cell, a thin film solar cell, an amorphous silicon-based solar cell, a polycrystalline silicon-based solar cell, or a strip thereof.

### PV Roofing Tiles and Multi-Tile Modules

A PV roofing tile (or solar roofing tile) is a type of PV module shaped like a roofing tile and typically enclosing fewer solar cells than a conventional solar panel. Note that such PV roofing tiles can function as both PV cells and roofing tiles at the same time. In some embodiments, the system disclosed herein can be applied to PV roofing tiles and/or other types of PV module.

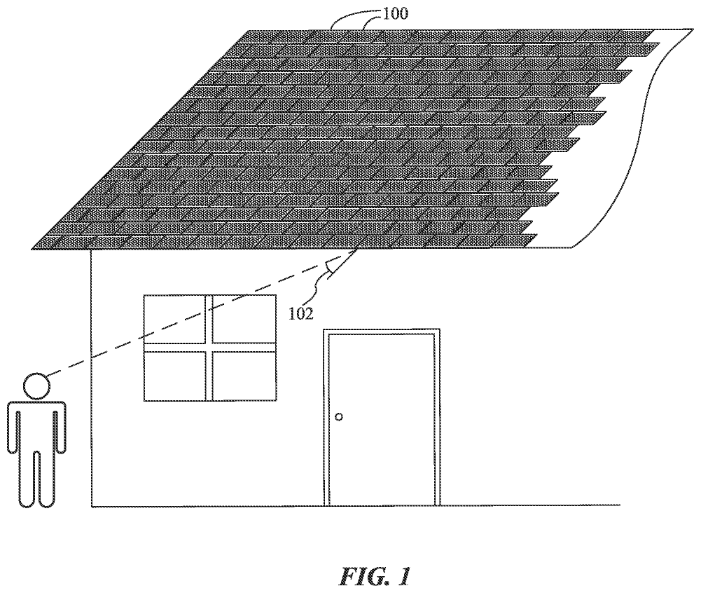

FIG. 1 shows an exemplary configuration of PV roofing tiles on a house. PV roofing tiles 100 can be installed on a house like conventional roofing tiles or shingles. Particularly, a PV roofing tile can be placed with other tiles in such a way as to prevent water from entering the building.

A PV roofing tile can enclose multiple solar cells or PV structures, and a respective PV structure can include one or more electrodes, such as busbars and finger lines. The PV structures within a PV roofing tile can be electrically and, optionally, mechanically coupled to each other. For example, multiple PV structures can be electrically coupled together by a metallic tab, via their respective busbars, to create serial or parallel connections. Moreover, electrical connections can be made between two adjacent tiles, so that a number of PV roofing tiles can jointly provide electrical power. Cosmetic features of the PV roofing tiles can allow the PV roofing tiles to blend in and look the same as non-PV roofing tiles. In some embodiments the cosmetic features can be designed to operate ideally when viewed from an angle 102.

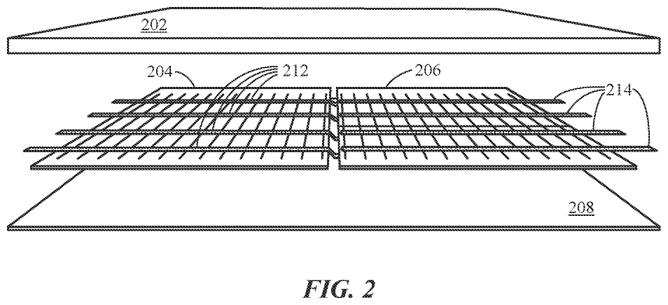

FIG. 2 shows a perspective view of an exemplary PV roofing tile, according to an embodiment. Solar cells 204 and 206 can be hermetically sealed between top glass cover 202 and PV back cover 208, which jointly can protect the solar cells from various weather elements. In the example shown in FIG. 2, metallic tabbing strips 212 can be in contact with the front-side electrodes of solar cell 204 and extend beyond the left edge of glass 202, thereby serving as contact electrodes of a first polarity of the PV roofing tile. Tabbing strips 212 can also be in contact with the back of solar cell 206, creating a serial connection between solar cell 204 and solar cell 206. On the other hand, tabbing strips 214 can be in contact with front-side electrodes of solar cell 206 and extend beyond the right edge of glass cover 202, serving as contact electrodes of a second polarity of the PV roofing tile. In some embodiments, PV back cover 208 can be a standard PV tile backer formed from one or more layers of polymer such as, e.g., fluoropolymers or combinations of PET and EVA layers. Alternatively, PV back cover 208 can take the form of a back glass cover.

In some embodiments, array of solar cells 204 and 206 can be encapsulated between top glass cover 202 and back cover 208. A top encapsulant layer, which can be based on a polymer, can be used to seal top glass cover 202 to array of solar cells 204/206. Specifically, the top encapsulant layer may include polyvinyl butyral (PVB), thermoplastic polyolefin (TPO), ethylene vinyl acetate (EVA), or N,N′-diphenyl-N,N′-bis(3-methylphenyl)-l,l′-diphenyl-4,4′-diamine (TPD). Similarly, a lower encapsulant layer, which can be based on a similar material, can be used to seal the array of solar cells to back cover 208. A PV roofing tile can also contain other optional layers, such as an optical filter or coating layer or a layer of nanoparticles for providing desired color appearances. In the example of FIG. 2, module or roofing tile 300 can also contains an optical filter layer between the array of solar cells and front glass cover 202.

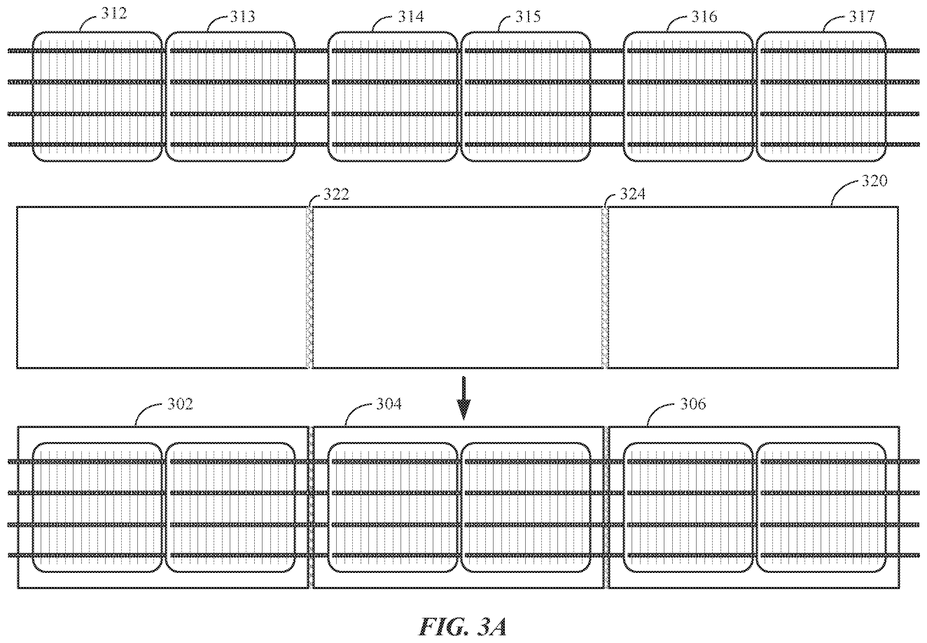

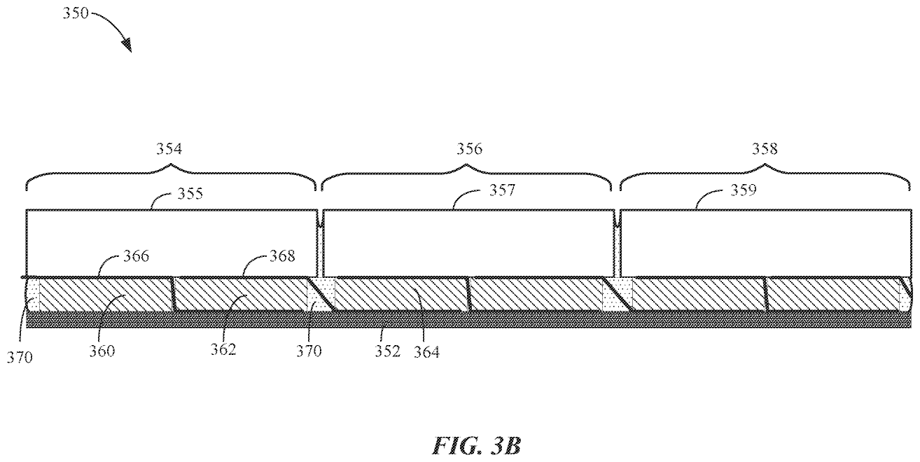

To facilitate more scalable production and easier installation, multiple PV roofing tiles can be fabricated together, while the tiles are linked in a rigid or semi-rigid way. FIG. 3A illustrates an exemplary configuration of a multi-tile module, according to one embodiment. In this example, three PV roofing tiles 302, 304, and 306 can be manufactured′ establishing a semi-rigid couplings 322 and 324 between adjacent tiles. Prefabricating multiple tiles into a rigid or semi-rigid multi-tile module can significantly reduce the complexity in roof installation, because the tiles within the module have been connected with the tabbing strips. Note that the number of tiles included in each multi-tile module can be more or fewer than what is shown in FIG. 3A.

FIG. 3B illustrates a cross-section of an exemplary multi-tile module, according to one embodiment. In this example, multi-tile module 350 can include PV roofing tiles 354, 356, and 358. These tiles can share common PV tile backer 352, and have three individual glass covers 355, 357, and 359, respectively. Each tile can encapsulate two solar cells. For example, tile 354 can include solar cells 360 and 362 encapsulated between PV tile backer 352 and glass cover 355. Tabbing strips can be used to provide electrical coupling within each tile and between adjacent tiles. For example, tabbing strip 366 can couple the front electrode of solar cell 360 to the back electrode of solar cell 362, creating a serial connection between these two cells. Similarly, tabbing strip 368 can couple the front electrode of cell 362 to the back electrode of cell 364, creating a serial connection between tile 354 and tile 356.

Gaps 322 and 324 between adjacent PV tiles can be filled with encapsulant, protecting tabbing strips interconnecting the two adjacent tiles from the weather elements. For example, encapsulant 370 fills the gap between tiles 354 and 356, protecting tabbing strip 368 from weather elements. Furthermore, the three glass covers, PV tile backer 352, and the encapsulant together form a semi-rigid construction for multi-tile module 350. This semi-rigid construction can facilitate easier installation while providing a certain degree of flexibility among the tiles.

In addition to the examples shown in FIGS. 3A and 3B, a PV tile may include different forms of PV structures. For example, in order to reduce internal resistance, each square solar cell shown in FIG. 3A can be divided into multiple (e.g., three) smaller strips, each having edge busbars of different polarities on its two opposite edges. The edge busbars allow the strips to be cascaded one by one to form a serially connected string.

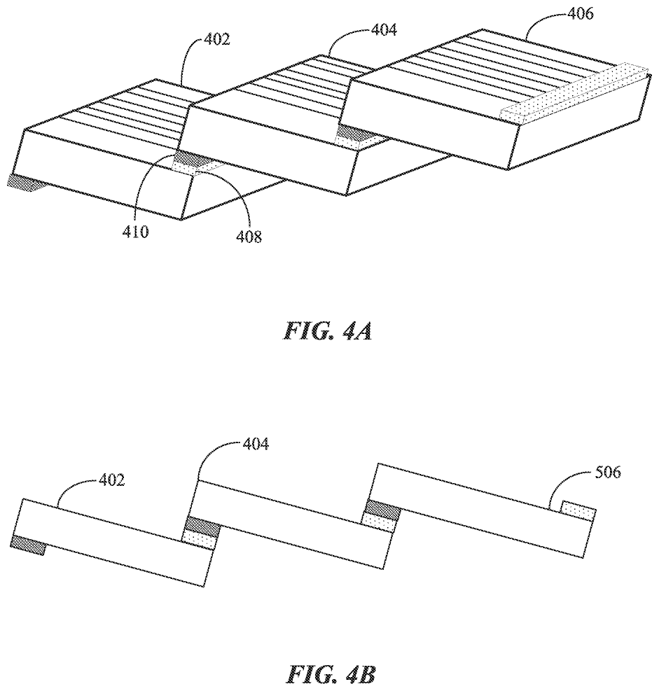

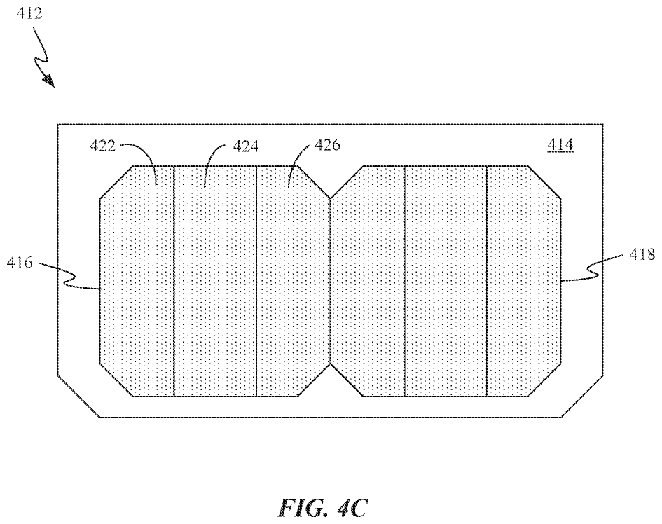

FIG. 4A illustrates a serial connection among three adjacent cascaded PV strips, according to one embodiment. In FIG. 4A, strips 502, 504, and 506 are stacked in such a way that strip 504 partially underlaps adjacent strip 506 to its right, and overlaps strip 502 to its left. The resulting string of strips forms a cascaded pattern similar to roof shingles. Strips 502 and 504 are electrically coupled in series via edge busbar 508 at the top surface of strip 502 and edge busbar 510 at the bottom surface of strip 504. Strips 502 and 504 can be arranged in such a way that bottom edge busbar 510 is above and in direct contact with top edge busbar 508. The coupling between strips 504 and 506 can be similar.

FIG. 4B illustrates a side view of the string of cascaded strips, according to one embodiment. In the example shown in FIGS. 4A and 4B, the strips can be segments of a six-inch square or pseudo-square solar cell, with each strip having a dimension of approximately two inches by six inches. To reduce shading, the overlapping between adjacent strips should be kept as small as possible. Therefore, in the example shown in FIGS. 4A and 4B, the single busbars (both at the top and the bottom surfaces) can be placed at or near the very edge of the strip. The same cascaded pattern can extend along multiple strips to form a serially connected string, and a number of strings can be coupled in series or parallel.

FIG. 4C illustrates an exemplary solar roofing tile, according to one embodiment. A solar roofing tile 412 includes top glass cover 414 and solar cells 416 and 418. The bottom cover (e.g., PV tile backer) of solar roofing tile 412 is out of view in FIG. 4C. Solar cells 416 and 418 can be conventional square or pseudo-square solar cells, such as six-inch solar cells. In some embodiments, solar cells 416 and 418 can each be divided into three separate pieces of similar size. For example, solar cell 416 can include strips 422, 424, and 426. These strips can be arranged in such a way that adjacent strips are partially overlapped at the edges, similar to the ones shown in FIGS. 4A-4B. For simplicity of illustration, the electrode grids, including the finger lines and edge busbars, of the strips are not shown in FIG. 4C. In addition to the example shown in FIG. 4C, a solar roofing tile can contain fewer or more cascaded strips, which can be of various shapes and size.

In some embodiments, multiple solar roofing tiles, each encapsulating a cascaded string, can be assembled to obtain a multi-tile module. Inner-tile electrical coupling has been accomplished by overlapping corresponding edge busbars of adjacent strips. However, inter-tile electrical coupling within such a multi-tile module can be a challenge. Strain-relief connectors and long bussing strips have been used to facilitate inter-tile coupling. However, strain-relief connectors can be expensive, and arranging bussing strips after laying out the cascaded strings can be cumbersome. To facilitate low-cost, high-throughput manufacturing of the solar roofing tiles, in some embodiments, metal strips can be pre-laid onto the back covers of the solar tiles, forming an embedded circuitry that can be similar to metal traces on a printed circuit board (PCB). More specifically, the embedded circuitry can be configured in such a way that it facilitates the electrical coupling among the multiple solar roofing tiles within a multi-tile module.

Moreover, to facilitate electrical coupling between the embedded circuitry and an edge busbar situated on a front surface of a cascaded string, in some embodiments, a Si-based bridge electrode can be attached to the cascaded string. The Si-based bridge electrode can include a metallic layer covering its entire back surface and, optionally, a back edge busbar. By overlapping its edge (e.g., back edge busbar) to the front edge busbar of the cascaded string, the Si-based bridge electrode can turn itself into an electrode for the cascaded string, converting the forwardly facing electrode of the cascaded string to an electrode accessible from the back side of the cascaded string.

FIG. 5A shows a top view of an exemplary multi-tile module, according to one embodiment. Multi-tile module 500 can include PV roofing tiles 502, 504, and 506 arranged side by side. Each PV roofing tile can include six cascaded strips encapsulated between the front and back covers, meaning that busbars located at opposite edges of the cascaded string of strips have opposite polarities. For example, if the leftmost edge busbar of the strips in PV roofing tile 502 has a positive polarity, then the rightmost edge busbar of the strips will have a negative polarity. Serial connections can be established among the tiles by electrically coupling busbars having opposite polarities, whereas parallel connections can be established among the tiles by electrically coupling busbars having the same polarity.

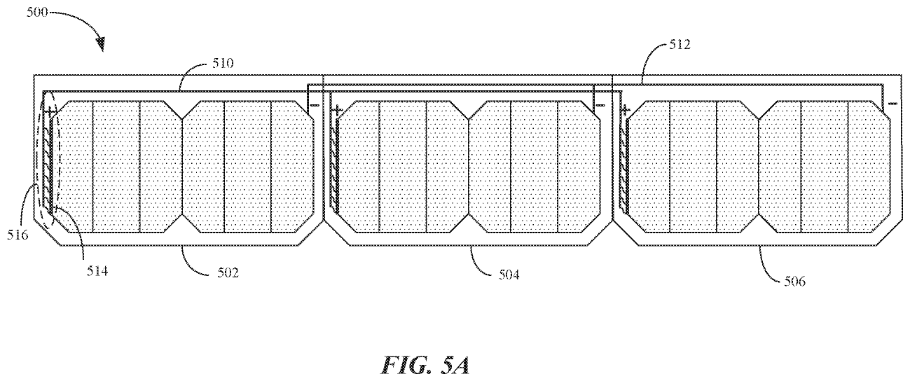

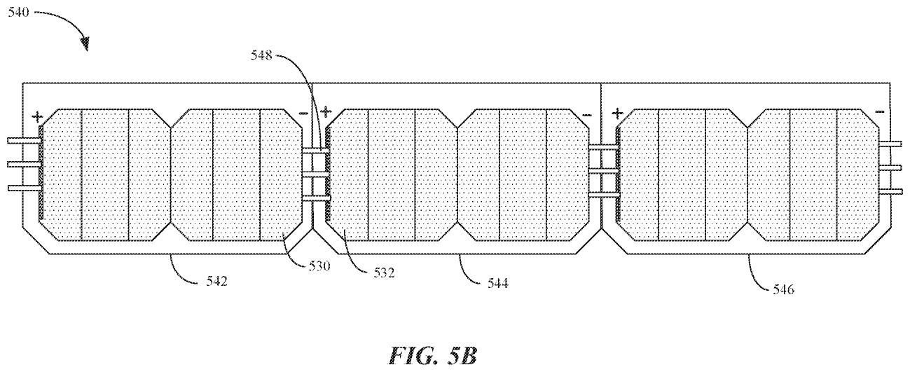

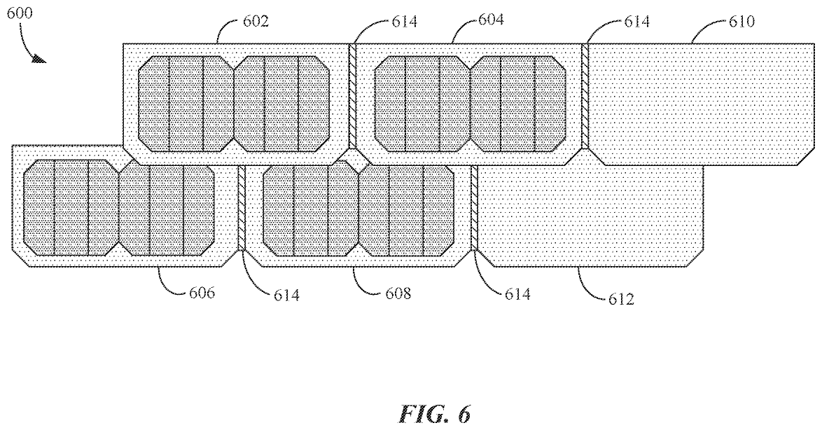

In the example shown in FIG. 5A, the PV roofing tiles are arranged in such a way that their sun-facing sides have the same electrical polarity. As a result, the edge busbars of the same polarity will be on the same left or right edge. For example, the leftmost edge busbar of all PV roofing tiles can have a positive polarity and the rightmost edge busbar of all PV roofing tiles can have a negative polarity, or vice versa. In FIG. 6, the left edge busbars of all strips have a positive polarity (indicated by the “+” signs) and are located on the sun-facing (or front) surface of the strips, whereas the right edge busbars of all strips have a negative polarity (indicated by the “−” signs) and are located on the back surface. Depending on the design of the layer structure of the solar cell, the polarity and location of the edge busbars can be different from those shown in FIG. 5A.

A parallel connection among the tiles can be formed by electrically coupling all leftmost busbars together via metal tab 510 and all rightmost busbars together via metal tab 512. Metal tabs 510 and 512 are also known as connection buses and typically can be used for interconnecting individual solar cells or strings. A metal tab can be stamped, cut, or otherwise formed from conductive material, such as copper. Copper is a highly conductive and relatively low-cost connector material. However, other conductive materials such as silver, gold, or aluminum can be used. In particular, silver or gold can be used as a coating material to prevent oxidation of copper or aluminum. In some embodiments, alloys that have been heat-treated to have super-elastic properties can be used for all or part of the metal tab. Suitable alloys may include, for example, copper-zinc-aluminum (CuZnAl), copper-aluminum-nickel (CuAlNi), or copper-aluminum-beryllium (CuAlBe). In addition, the material of the metal tabs disclosed herein can be manipulated in whole or in part to alter mechanical properties. For example, all or part of metal tabs 510 and 512 can be forged (e.g., to increase strength), annealed (e.g., to increase ductility), and/or tempered (e.g. to increase surface hardness).

The coupling between a metal tab and a busbar can be facilitated by a specially designed strain-relief connector. In FIG. 5A, strain-relief connector 516 can be used to couple busbar 514 and metal tab 510. Such strain-relief connectors are needed due to the mismatch of the thermal expansion coefficients between metal (e.g., Cu) and silicon. As shown in FIG. 5A, the metal tabs (e.g., tabs 510 and 512) may cross paths with strain-relief connectors of opposite polarities. To prevent an electrical short of the PV strips, portions of the metal tabs and/or strain-relief connectors can be coated with an insulation film or wrapped with a sheet of insulation material.

In some embodiments, instead of parallelly coupling the tiles within a tile module using stamped metal tabs and strain-relief connectors as shown in FIG. 5A, one can also form serial coupling among the tiles. FIG. 5B shows the top view of an exemplary multi-tile module, according to one embodiment. Tile module 540 can include solar roofing tiles 542, 544, and 546. Each tile can include a number (e.g., six) of cascaded solar cell strips arranged in a manner shown in FIGS. 4A and 4B. Furthermore, metal tabs can be used to interconnect PV strips enclosed in adjacent tiles. For example, metal tab 648 can connect the front of strip 632 with the back of strip 630, creating a serial coupling between strips 630 and 632. Although the example in FIG. 5B shows three metal tabs interconnecting the PV strips, other numbers of metal tabs can also be used. Furthermore, each solar roofing tile can contain fewer or more cascaded strips, which can be of various shapes and sizes.

For simplicity of illustration, FIGS. 5A and 5B do not show the inter-tile spacers that provide support and facilitate mechanical and electrical coupling between adjacent tiles. Detailed descriptions of such inter-tile spacers can be found in U.S. Patent Publication US20190260328A1, entitled “INTER-TILE SUPPORT FOR SOLAR ROOF TILES,” the disclosure of which is incorporated herein by reference in its entirety.

### Color Matching in Solar Roofing Tiles

As shown in FIG. 4C, FIG. 5A, and FIG. 5B, the PV structures and external electrodes encapsulated between the front and back covers can appear different than the background when viewed from the side of the transparent and colorless front cover. More specifically, the Si-based PV structures often appear to have a blue/purple hue. Although applying color onto the back cover can improve the color matching between the PV structures and the background, they cannot solve the problem of angle-dependence of color. In other words, the PV structures may appear to have different colors at different viewing angles, making color-matching difficult. Moreover, apart from solar roofing tiles, a roof can sometimes include a certain number of “passive” or “dead” roofing tiles, i.e., roofing tiles that do not have embedded solar cells. These passive roofing tiles can merely include the front and back covers and encapsulant sandwiched between the covers. The difference in appearance between the solar roofing tiles and the passive roofing tiles often results in a less pleasing aesthetic.

FIG. 6 shows a partial view of a roof having a number of solar roofing tiles and passive roofing tiles. In FIG. 6, roof 600 can include a number of roofing tiles arranged in such a fashion that the lower edges of tiles in a top row overlap the upper edges of tiles in a bottom row, thus preventing water leakage. Moreover, the tiles are offset in such a manner that the gap between adjacent tiles in one row somewhat aligns with the center of a tile located in a different row. In the example shown in FIG. 6, tiles 602, 604, 606, and 608 are solar roofing tiles, which can include PV structures encapsulated between front and back covers, and tiles 610 and 612 are passive roofing tiles. As one can see from the drawing, the color contrast between the back covers and the PV structures can create a “picture frame” appearance of the solar roofing tiles. In fact, the PV structures often appear to be “floating” above the colored back covers. Ideally, solar roofing tiles 602-608 should have a similar appearance as passive roofing tiles 610 and 612. Spacers 614 can fill gaps between adjacent tiles and prevent the passage of water between PV tiles 602-608. In some embodiments, spacers 614 can include electrical conductors that accommodate the passage of electricity and/or signals between adjacent PV tiles. In some embodiments, spacers 614 can define channels through which wires or similar conductors can carry the electricity and/or signals between the adjacent PV tiles.

### Roofing Tile Base

The described embodiments include a universal roofing tile base that is configured to support multiple different types of roofing tiles, including photovoltaic (PV) and non-PV roofing tiles. A roofing substrate of a building can be covered with these universal roofing tile bases, thereby alleviating the need to add battens (e.g., horizontal strips of solid material) and/or discrete feet to support roofing tiles above a roofing substrate. Each of the roofing tile bases can be the same, meaning that aside from minor manufacturing variations the roofing tile bases have the same size and share the same features and material properties. This prevents any confusion with mistakenly using the wrong base for the wrong type of roofing tile.

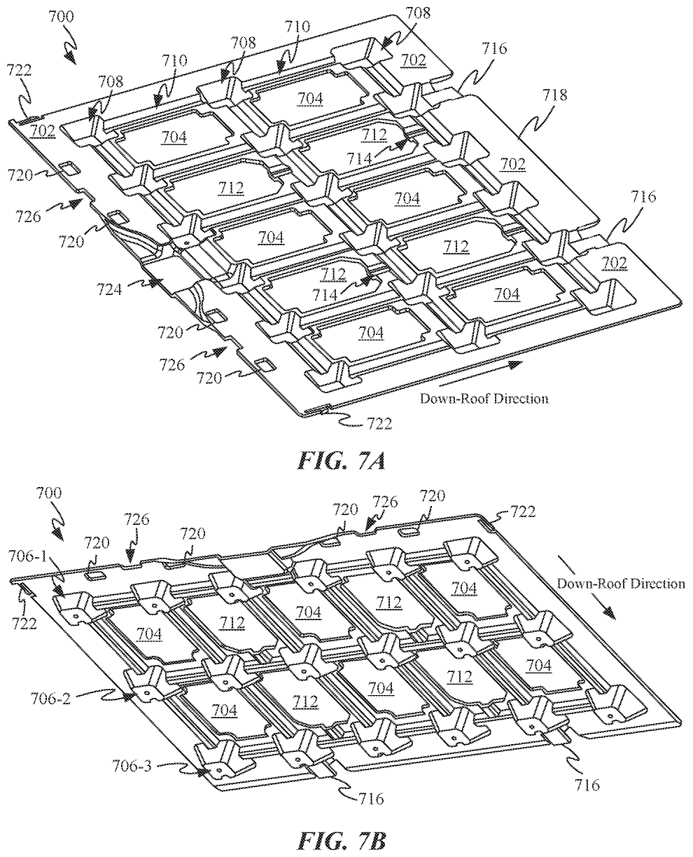

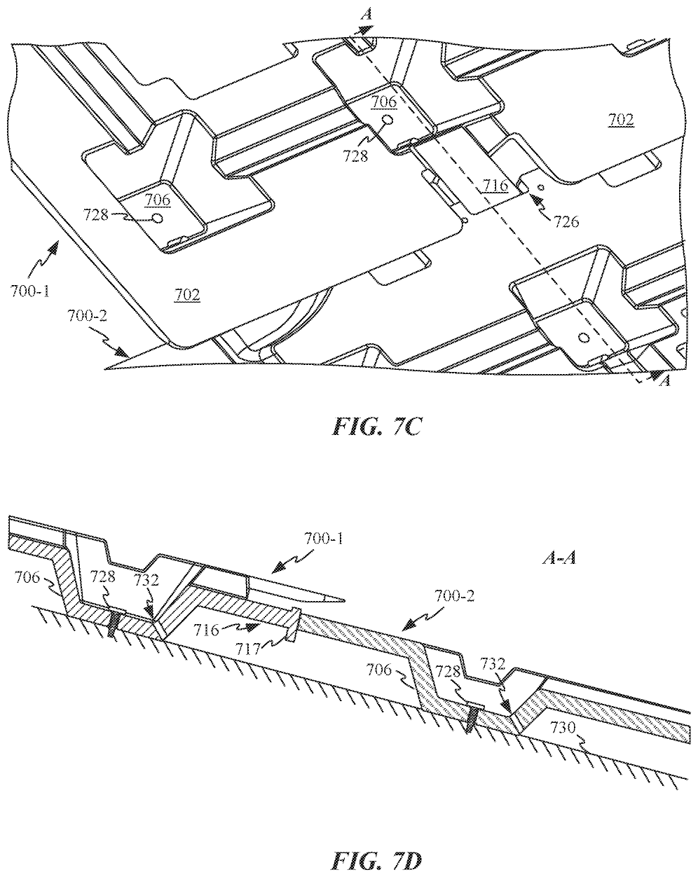

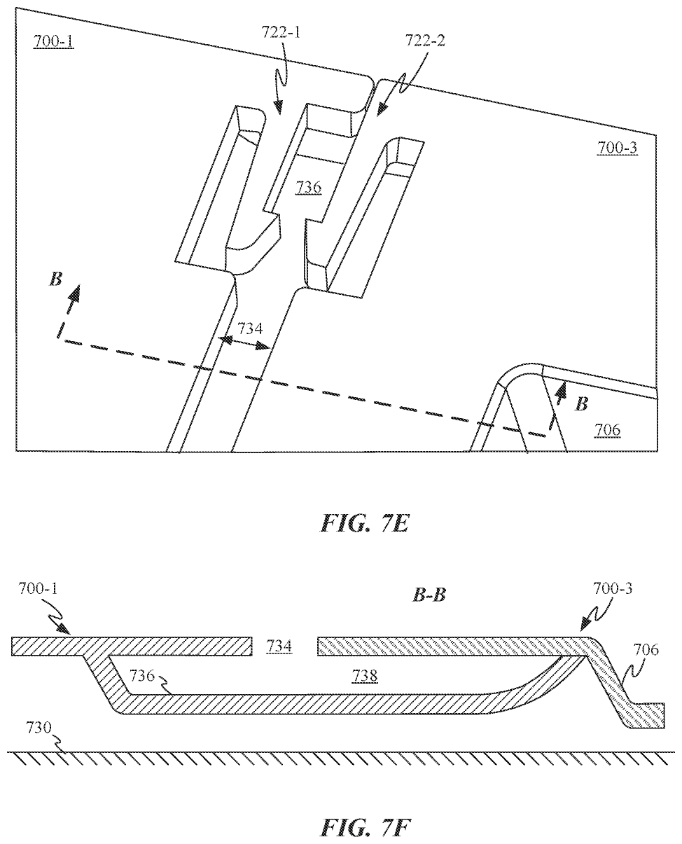

FIGS. 7A-7B show perspective views of respective sun-facing and roof facing surfaces of a roofing tile base 700. Roofing tile base can be formed using an injection molded process that allows for the depicted complex shape to be mass produced at a relatively low cost. Injection molding materials used to form a roofing tile base can include, for example, polymeric and foam materials. Roofing tile base 700 can also take the form of a sheet-formed part, a sheet molded composite part, a stamped part or a cast metal part. Roofing tile base 700 is configured to support either a PV roofing tile or a non-PV roofing tile. FIG. 7A shows how roofing tile base 700 includes a flat, sun-facing surface 702 configured to support a PV roofing tile or non-PV roofing tile atop a rooftop. Roofing tile base 700 includes multiple apertures 704 configured to accommodate the passage of one or more tile hooks affixed to a roof-facing surface of a PV roofing tile supported by roofing tile base 700.

FIG. 7B shows how roofing tile base 700 also includes multiple vertical standoffs 706 that help establish a height and orientation of a PV or non-PV roofing tile above a roofing substrate. For example, a height of vertical standoff 706-1 as shown in FIG. 7B is less than a height of vertical standoff 706-2, which in turn is less than a height of vertical standoff 706-3. This allows a down-roof portion of a roofing tile affixed to roofing tile base 700 to be elevated slightly more above a roofing substrate than its up-roof end, thereby allowing a down-roof end of a first row of roofing tiles to slightly overlap an up-roof end of a second row of roofing tiles located immediately below the first row of roofing tiles. Relative to more conventional support structures that concentrate weight of roofing tiles on a roofing substrate, the large number of vertical standoffs allow for an even distribution of weight across the roofing substrate, thereby making larger roofing tiles possible. Furthermore, it should be appreciated that a pattern and/or layout of vertical standoffs can be arranged to suit a particular roofing configuration. For example, vertical standoffs could be arranged in a pattern that matches framing of the roof to which it is affixed. This can help assure that weight is transferred directly to the structural framing members of the roof, which can reduce the load on sheathing extending across gaps between the structural framing members and allow fasteners to directly engage the solid wood of the framing members instead of the plywood generally used as sheathing material, thereby making the roof less susceptible to high wind scenarios. In some embodiments, spacing the vertical standoffs in this manner can help to affix roofing tile bases directly to the structural framing members of the roof without the need for a traditional roofing substrate formed from roof purlins or roof sheathing. In such a configuration, the structural framing members would constitute the roofing substrate. Adapting the vertical standoff members in this way can result in an irregular interval between vertical standoffs to accommodate roofs adapting particular structural frame member spacing.

FIG. 7A also shows how standoffs 706 define recesses 708 that help to reduce an overall weight of roofing tile base 700 and also in cooperation with cable channels 710 allow for the routing of cabling between a PV-roofing tile and roofing tile base 700. Roofing tile base also defines multiple apertures 712 that allow for the passage of any cabling associated with a PV roofing tile to pass through an aperture 712, which in turn allows the cabling to be routed between roofing tile base 700 and a roofing substrate. Exit channels 714 allow any cabling being routed through recesses 708 and cable channels 110 to exit a respective cable channel 110 and through an aperture 712 for routing beneath roofing tile base 700. Roofing tile base 700 also includes lateral standoffs 716 that help set a position of roofing tile base 700 with respect to a roofing tile base positioned one row below roofing tile base 700. Lateral standoffs 716 are positioned below sun-facing surface 702 and slightly behind a leading edge 718 of roofing tile base 700, thereby allowing leading edge 718 to overlap an up-roof portion of a roofing tile base adjacent to roofing tile base 700.

Roofing tile base 700 further includes multiple non-PV tile retaining features that include retaining features 720 and 722. Retaining features 720 and 722 are configured to prevent movement of a non-PV tile relative to roofing tile base 700 and their function will be described in greater detail below. Roofing tile base 700 also defines an electrical component recess 724 for accommodating electrical inputs/outputs arranged on a roof-facing surface of a PV roofing tile. In some embodiments, electrical component recess 724 can accommodate a junction box configured to protect electrical lines running into and out of the PV roofing tile. FIGS. 7A-7B also show how an up-roof facing edge of roofing tile base 700 includes alignment notches 726, which are configured to receive a lateral standoff 716 from an up-roof roofing tile base. A shape and size of alignment notches 726 have a shape and size matching a distal end of a lateral standoff 716, which helps achieve a consistent horizontal offset between roofing tile bases on adjacent rows of roofing tile bases.

FIG. 7C shows engagement of a lateral standoff 716 within an alignment notch 726. FIG. 7C also demonstrates how a forward or leading edge of a down-roof facing portion of roofing tile base 700-1 overlaps an up-roof facing portion of roofing tile base 700-2 when lateral standoff 716 is engaged within alignment notch 726. FIG. 7C also illustrates how a lateral edge of roofing tile base 700-1 is aligned with a central region of roofing tile base 700-2 when lateral standoff 716 engages alignment notch 726 resulting in a half-tile offset between adjacent rows of roofing tiles. In some embodiments, a roofing tile base can include a larger number of alignment notches 726 allowing for more horizontal offset options to accommodate a customer's preference. FIG. 7C also shows how roofing tile base 700 can be secured to a roofing substrate with one or more fasteners 728 driven through vertical standoffs 706. In some embodiments, vertical standoffs 706 can include a fastener opening making attachment of a roofing tile base 700 to a roofing substrate 730 easier.

FIG. 7D shows a cross-sectional view of roofing tile bases 700-1 and 700-2 in accordance with section line A-A from FIG. 7C. In particular, FIG. 7D shows how lateral standoff 716 makes abutting contact with alignment notch 726 to establish a predetermined amount of overlap of roofing tile base 700-1 over roofing tile base 700-2. In some embodiments, a distal end 717 of lateral standoff 716 can be widened vertically, as depicted, in order to avoid alignment problems when undulations or irregularities in a surface of the roofing substrate results in a variation in vertical position of a respective roofing tile base. FIG. 7D also shows how vertical standoffs can include drainage channels that allow any moisture collecting within a recess defined by a respective vertical standoff to flow out of the vertical standoff.

FIG. 7E shows a perspective view of corner portions of laterally adjacent roofing tile bases 700-1 and 700-3. In particular, retaining features 722-1 and 722-2 are positioned in close proximity and separated by a gap 734 having a width allowing sufficient clearance for PV and/or non-PV roofing tiles to be positioned atop roofing tile bases 700-1 and 700-2. FIG. 7E also shows roofing tile base 700-1 can include an integrated sidelap 736 that extends beneath gap 734 to guide moisture passing between roofing tile bases 700-1 and 700-3 down-roof to prevent the moisture from collecting on roofing substrate 730.

FIG. 7F shows a cross-sectional view of roofing tile bases 700-1 and 700-3 in accordance with section line B-B. In particular, integrated sidelap 736 is shown extending beneath gap 734. As depicted, integrated sidelap 736 defines a channel 738 helping to guide any moisture passing through gap 734 down-roof to empty out atop PV or non-PV roof tiles down-roof from roofing tile bases 700-1 and 700-3. As depicted, integrated sidelap 736 is sized to also act as a lateral standoff by engaging a wall of vertical standoff 706.

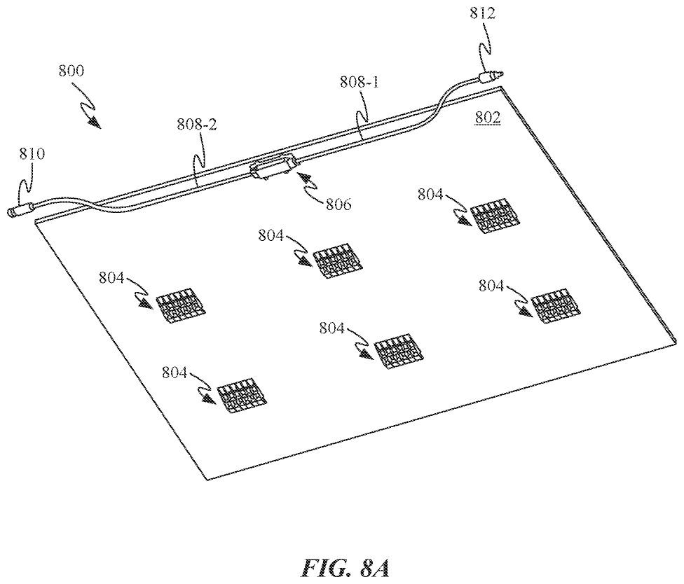

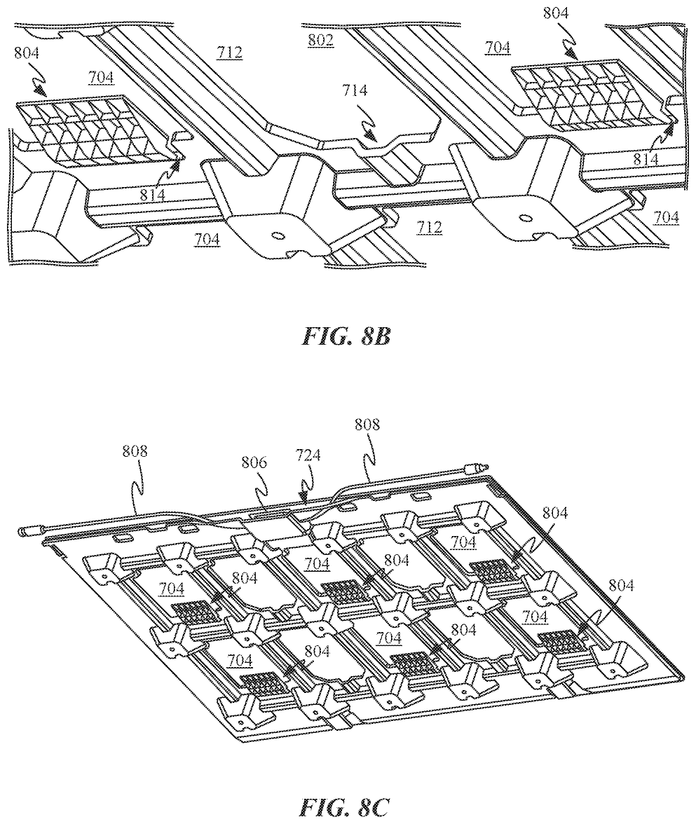

FIG. 8A shows a perspective view of a PV roofing tile 800. In particular, a roof-facing surface 802 of PV roofing tile 800 is depicted. FIG. 8 shows six tile hooks 804 attached to roof-facing surface 802 of PV roofing tile 800. Tile hooks 804 are configured to extend through apertures 704 of a roofing tile base 700 to attach PV roofing tile 800 to PV roofing tile base 700. While PV roofing tile 800 includes six tile hooks 804 it should be appreciated that a smaller number such as four or a larger number of tile hooks 804 such as eight or ten tile hooks 804 could be included on roofing tile 800 depending on a desired size of PV roofing tile 800. Generally, a number of tile hooks 804 will scale with a size of roofing tile 800. In some embodiments, roofing tile base 700 could have four tile hooks 804 and still be compatible with roofing tile base 700 as depicted in FIGS. 7A-7F. For example, a central two of tile hooks 804 could be removed and tile hooks 804 could still be configured to engage edges of peripheral apertures 704 of roofing tile base 700. In the event that a spacing of vertical standoffs 706 is varied to accommodate a particular roof construction, a location of tile hooks 804 can be shifted to account for changes in positioning of vertical standoffs 706 and the apertures 704 between vertical standoffs 706 that receive tile hooks 804.

FIG. 8A also shows how a junction box 806 can be attached to roof-facing surface 802 of PV roofing tile 800. Junction box 806 can be configured to assist with electrically coupling cables 808-1 and 808-2 to electricity generating solar cells contained within PV roofing tile 800. Each of cables 808 can include a female plug 810 or a male plug 812 for electrically coupling PV roofing tile 800 to adjacent PV roofing tiles and/or other electrical components making. While an interior of PV roofing tile 800 is not depicted in FIG. 8A, PV roofing tile 800 can be configured in different ways as described in FIGS. 2-6. As described in FIGS. 2-6, PV roofing tile 800 includes a back cover that includes roof-facing surface 802, a front cover that includes a sun-facing surface and multiple solar cells positioned between the front and back covers.

FIG. 8B shows a perspective view of a PV roofing tile 800 positioned atop a roofing tile base 700. Tile hooks 804 are shown extending through a respective aperture 704 so that tile hook 804 is aligned with an indentation 814 in the portion of roofing tile base 700 that defines the respective aperture 704. Indentation 814 has a width that matches (i.e., is the same as or slightly larger than) a width of tile hook 804, which allows indentation 814 to help achieve horizontal alignment of PV roofing tile 800 with roofing tile base 700. Exit channel 714, in addition to provide a way to route one or more cables out of an area between PV roofing tile 800 and roofing tile base 700 also prevents an installer from attaching a tile hook 804 to an edge of one of apertures 712 on account of tile hook 804 being insufficient in height to slip over exit channel 714.

FIG. 8C shows PV roofing tile 800 fully engaged with roofing tile base 700. This engagement can be confirmed by observing that PV roofing tile 800 is aligned with roofing tile base 700 and that each of tile hooks 804 is engaged with an edge of one of apertures 704. FIG. 8C also shows how junction box 806 fits within and is accommodated by electrical component recess 724. A shape of electrical component recess 724 is formed to allow cables 808 to extend out of opposing sides of junction box 806 and then bend gradually to exit electrical component recess 724.

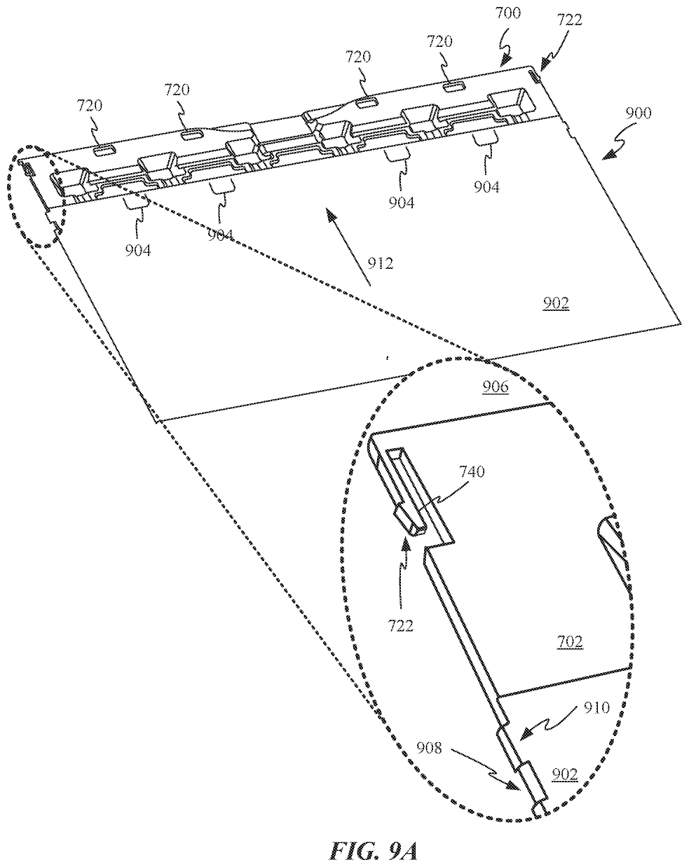

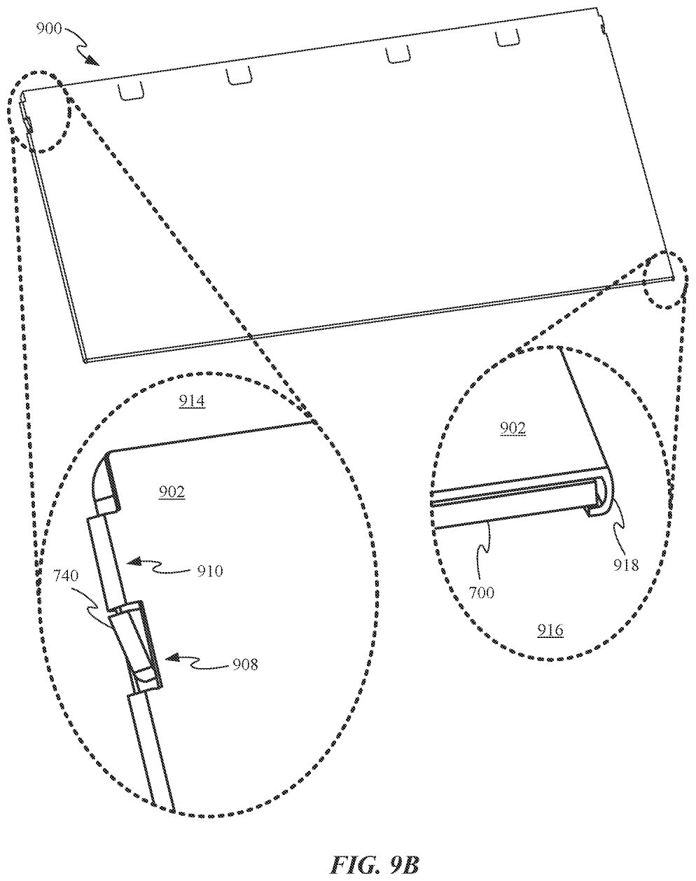

FIG. 9A shows a non-PV roofing tile 900 and how it is configured to slide on to roofing tile base 700. Non-PV roofing tile 900 can be formed of sheet metal in some embodiments and a sun-facing surface 902 of non-PV roofing tile 900 can be finished to have an appearance that matches a sun-facing surface of PV roofing tile 800, which is generally formed of glass or an optically transparent polymeric material. In some embodiments, non-PV roofing tile 900 includes multiple flaps 904 positioned to line up with retaining features 720. As depicted, retaining features 720 are embodied as rectangular apertures positioned along an up-roof facing end of roofing tile base 700. Flaps 904 are created by cutting a U-shaped slot in the sheet metal substrate of sun-facing surface 902 of non-PV roofing tile 900 as depicted. Once non-PV roofing tile 900 slides fully cover roofing tile base 700, an installer can bend flaps 904 downward 5-10 degrees to engage a sidewall defining a respective one of retaining features 720. In this way, any downward force being applied to non-PV roofing tile 900 can be resisted by the engagement of distal ends of flaps 904 with sidewalls of retaining features 720. It should be noted that while the deflection of flaps 904 downward provides a potential ingress path for moisture, because of the position of flaps 904 at an up-roof end of non-PV roofing tile 900, up-roof roofing tiles generally overlap this portion of non-PV roofing tile thereby reducing the likelihood of any moisture entering through the small openings caused by deflection of flaps 904.

FIG. 9A also includes close up view 906 showing retaining feature 722 of roofing tile base 700 and a notch 908 included in a sidewall of non-PV roofing tile 900. Retaining feature 722 takes the form of a tab with a wedge shaped head 740 configured to deflect inwards once engaged by a sidewall segment 910 of non-PV roofing tile 900 as non-PV roofing tile 900 is being slid in installation direction 912. Notch 908 allows wedge shaped head 740 of retaining feature 722 to enter into notch 908 and thereby return to its initial position once non-PV rooftile 900 is fully covering roofing tile base 700.

FIG. 9B shows non-PV roofing tile 900 fully engaged with a roofing tile base. In particular, close up view 914 shows how wedge shaped head 740 of roofing tile base 700 occupies notch 908 of non-PV roofing tile 900. Furthermore, once wedge shaped head 740 is engaged within notch 908 an up-roof facing surface of wedge shaped head 740 can be configured to prevent sidewall segment 910 from moving down roof, thereby providing an additional way in which non-PV roofing tile 900 is secured to roofing tile base 700. A roof worker is also able to disengage non-PV roofing tile 900 from roofing tile base 700 by pressing in on wedge shaped head 740 to allow sidewall segment 910 to be disengaged from wedge shaped head 740 to allow PV roofing tile to slide down roof and off of roofing tile base 700. It should be appreciated that non-PV roofing tile base can include numerous retaining features including those described herein. For example, in lieu of engaging retaining features 720 with flaps 904, non-PV roofing tile 900 could include fastener openings allowing installers to drive one or more fasteners through non-PV roofing tile 900 and into roofing tile base 700.

FIG. 9B also includes close up view 916, which shows a geometry of a sidewall of non-PV roofing tile 900 and how sidewall 918 wraps at least partially below a lateral side of roofing tile base 700. While only a slight extension of sidewall 918 is depicted, it should be appreciated that sidewall 918 can wrap farther beneath roofing tile base 700 to reduce a possibility of sidewall 918 from becoming inadvertently disengaged from roofing tile base 700.

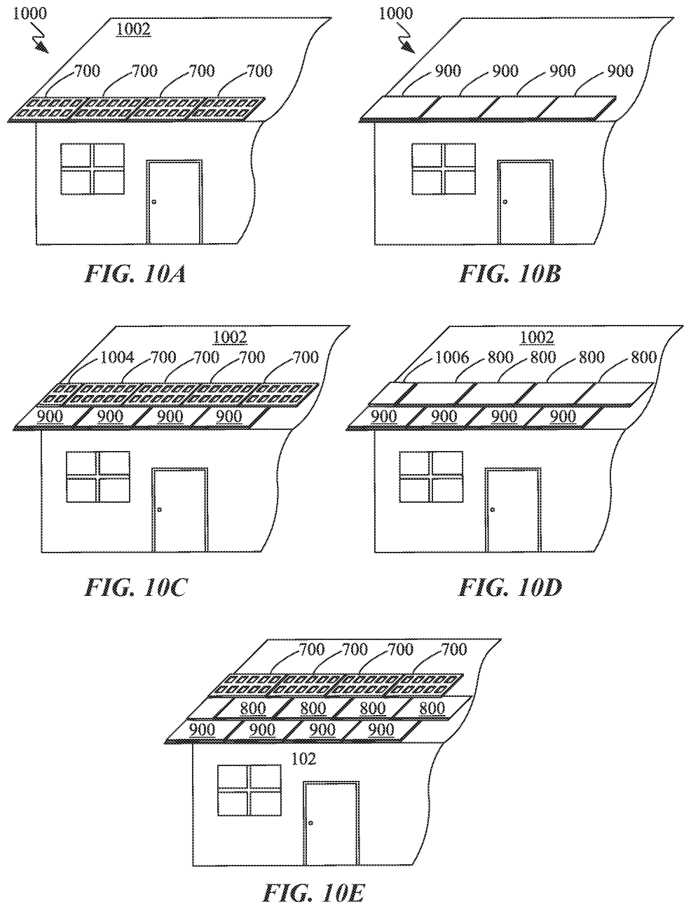

FIGS. 10A-10E depict an exemplary process for installing roofing tiles on multiple roofing tile bases on a house 1000. In particular, FIG. 10A shows how multiple roofing tile bases 700 can be secured to roofing substrate 1002. One or more fasteners are generally used to secure at least this first row of roofing tile bases to roofing substrate 1002. FIG. 10B shows how this first row of roofing tile bases 700 can then be covered by non-PV roofing tiles 900. Installation of non-PV roofing tiles 900 includes sliding non-PV roofing tiles 900 up-roof and over respective roofing tile bases 700 until retaining features of roofing tile bases 700 engage sidewalls of the non-PV roofing tiles 900. For embodiments in which non-PV roofing tiles 900 include flaps for engaging retaining features of roofing tile bases 700, an installer can also bend the flaps into apertures defined by roofing tile bases 700 to further prevent inadvertent movement of non-PV roofing tiles 900 with respect to roofing tile bases 700.

FIG. 10C shows installation of a second row of roofing tile bases 700. Of particular note, roofing tile base 1004 is not depicted as having a full width similar to roofing tile bases 700. Because roofing tile bases 700 are formed of a polymeric material or other material allowing for straight forward cutting into a desired shape, roofers are able to cut a roofing tile base to shape so that roofing tile bases can fit any portion of a roofing substrate. While roofing tile base 1004 is shown simply being narrower, more complex shape changes are also possible. For example, a circular or rectangular hole could be punched in a roofing tile base in order to accommodate passage of a vent. A non-PV roofing tile formed of sheet metal could also be reshaped in this manner. For example, FIG. 10D shows how a portion of a non-PV roofing tile 1006 can overlay roofing tile base 1004. In this way a portion of roofing substrate 1002 that would not otherwise fit a regularly sized roofing tile can be covered with a roofing tile, which aside from size has the same look and feel of the other roofing tiles. FIG. 10D also shows how PV roofing tiles 800 can be lowered onto the second row of roofing tile bases, thereby demonstrating PV roofing tiles intermixed with non-PV roofing tiles. FIG. 10E shows a third row of roofing tile bases 700 added above and slightly overlapping PV roofing tiles 800. The third row of roofing tile bases 700 can include PV or non-PV roofing tiles or a mixture of both since roofing tile bases 700 are equally suited for accommodating PV and non-PV roofing tiles.

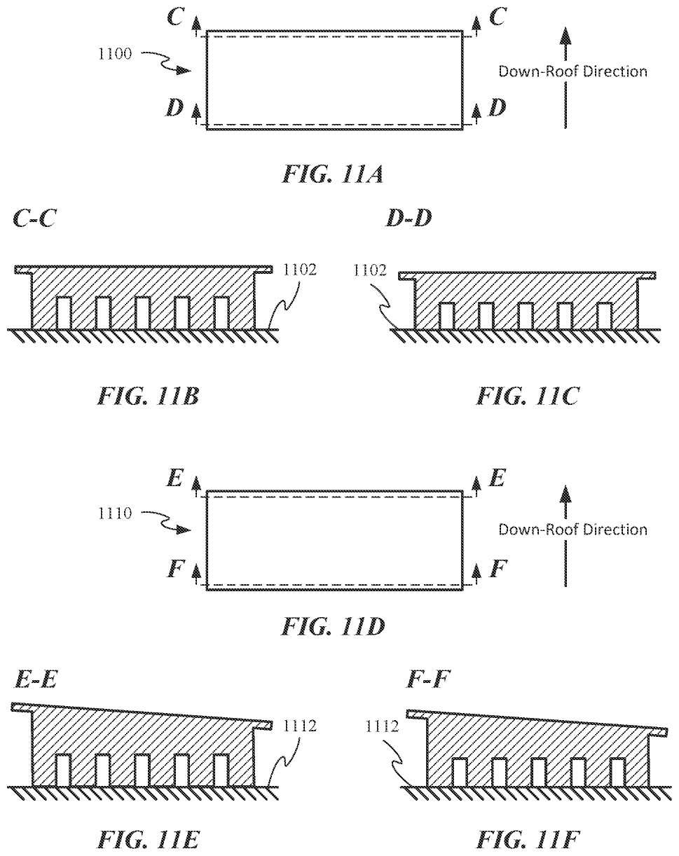

FIGS. 11A-11F show how a height of various portions of a roofing tile base varies. FIG. 11A shows a top view of a roofing tile base 1100 with section line C-C crossing a down-roof end of roofing tile base 1100 and section line D-D crossing an up-roof end of roofing tile base 1100. In particular and as describe previously, the down-roof end of roofing tile base 1100 as shown in FIG. 11B is extends higher above roofing substrate 1102 than the up-roof end of roofing tile base 1100 as shown in FIG. 11C to allow the down-roof end to overlap an up-roof end of a roofing tile positioned one row down from roofing tile base 1100. An angle of a sun-facing surface of roofing tile base 1100 from an up-roof end to a down-roof end can be set at between about 0.5 and 2 degrees. The depicted embodiments shown herein are based on a 1 degree angle.

FIG. 11D shows a top view of a roofing tile base 1110 with section line E-E crossing a down-roof end of roofing tile base 1110 and section line F-F crossing an up-roof end of roofing tile base 1110. In particular, cross-sectional views shown in FIGS. 11E-11F illustrate how each corner region of roofing tile base 1110 can be at a different height above roofing substrate 1112. This variance in height results from roofing tile base 1110 varying a height of its sun-facing surface above roofing substrate 1112 from left to right as well as from up-roof end to down-roof end. In some embodiments, tilting an angle of the roofing tiles from left to right reduces an appearance of unevenness resulting from irregularities in the roofing substrate. The variance in height from a first lateral side of a roofing tile base to a second lateral side of the roofing tile base can be obtained by setting an angle of between one and three degrees.

The foregoing descriptions of various embodiments have been presented only for purposes of illustration and description. They are not intended to be exhaustive or to limit the present system to the forms disclosed. Accordingly, many modifications and variations will be apparent to practitioners skilled in the art. Additionally, the above disclosure is not intended to limit the present system.

What is claimed is:

1. A roofing tile assembly, comprising:
a photovoltaic (PV) roofing tile, comprising:
an optically transparent front cover;
a back cover;
a plurality of solar cells disposed between the optically transparent front cover and the back cover; and
a plurality of tile hooks coupled to the back cover; and
a roofing tile base, comprising:
a sun-facing surface in direct contact with the back cover and extending from a first lateral side of the roofing tile to a second lateral side of the roofing tile opposite the first lateral side;
a plurality of vertical standoffs configured to establish a height of the sun-facing surface above a roofing substrate; and
a plurality of apertures extending through the roofing tile base, wherein a first tile hook of the plurality of tile hooks extends through a first aperture of the plurality of apertures and engages a portion of the roofing tile base defining the first aperture.

2. The roofing tile assembly of claim 1, wherein the roofing tile base comprises a plurality of lateral standoffs protruding from a down-roof facing end of the roofing tile base below a sun-facing surface of the roofing tile base.

3. The roofing tile assembly of claim 2, wherein the roofing tile base further comprises a plurality of alignment notches extending into the sun-facing surface of the roofing tile base.

4. The roofing tile assembly of claim 3, wherein the plurality of alignment notches are configured to receive a lateral standoff of another roofing tile base up-roof of the roofing tile base.

5. The roofing tile assembly of claim 1, wherein the plurality of vertical standoffs comprises four or more vertical standoffs.

6. The roofing tile assembly of claim 1, wherein the roofing tile base is a single injection molded piece.

7. The roofing tile assembly of claim 6, wherein the roofing tile base is formed from a polymeric material.

8. The roofing tile assembly of claim 1, wherein the PV roofing tile comprises a junction box coupled to the back cover and the roofing tile base defines an electrical component recess that accommodates a height of the junction box between the roofing tile base and the back cover.

9. The roofing tile assembly of claim 1, wherein the roofing tile base includes a plurality of retaining features configured to attach the roofing tile base to a non-PV roofing tile.

10. The roofing tile assembly of claim 1, wherein a first vertical standoff of the plurality of vertical standoffs is larger than a second standoff of the plurality of vertical standoffs.

11. The roofing tile assembly of claim 1, wherein bottom surfaces of the plurality of vertical standoffs cooperatively define a first plane anti-parallel to the sun-facing surface.

12. The roofing tile assembly of claim 1, wherein the roofing tile base is configured to position a first corner region of the sun-facing surface a first distance from a roofing substrate, a second corner region of the sun-facing surface a second distance from the roofing substrate, a third corner region of the sun-facing surface a third distance from the roofing substrate and a fourth corner region of the sun-facing surface a fourth distance from the roofing substrate.

13. The roofing tile assembly of claim 12, wherein the first distance is greater than the second distance, the second distance is greater than the third distance and the third distance is greater than the fourth distance.

14. The roofing tile assembly of claim 1, wherein the roofing tile base further comprises an integrated sidelap protruding from a lateral side of the roofing tile base and configured to extend beneath a gap between the roofing tile base and another roofing tile base adjacent to the roofing tile base.

15. A roofing tile assembly, comprising:
a non-photovoltaic (non-PV) roofing tile, comprising:
a sheet metal substrate comprising:
a flat central region;
a first sidewall at a first end of the flat central region and defining a first notch; and
a second sidewall at a second end, opposite the first end, of the flat central region and defining a second notch; and
a roofing tile base, comprising:
a sun-facing surface in direct contact with the flat central region and extending from the first sidewall to the second sidewall;
a plurality of vertical standoffs configured to establish a height of the sun-facing surface above a roofing substrate;
a first retaining feature on a first lateral side of the roofing tile base engaged within the first notch of the first sidewall; and
a second retaining feature on a second lateral side of the roofing tile base engaged within the second notch of the second sidewall.

16. The roofing tile assembly of claim 15, wherein the roofing tile base comprises a plurality of lateral standoffs protruding from a down-roof facing end of the roofing tile base below a sun-facing surface of the roofing tile base.

17. The roofing tile assembly of claim 16, wherein the roofing tile base further comprises a plurality of alignment notches extending into the sun-facing surface of the roofing tile base.

18. The roofing tile assembly of claim 17, wherein the plurality of alignment notches are configured to receive a lateral standoff of another roofing tile base up-roof of the roofing tile base.

19. The roofing tile assembly of claim 15, wherein the plurality of vertical standoffs comprises four or more vertical standoffs.

20. The roofing tile assembly of claim 15, wherein the roofing tile base is a single injection molded piece.
